(19) United States
(12) Patent Application Publication
(10) Pub. No.: US 2022/0184791 A1
(43) Pub. Date: Jun. 16, 2022

(54) Center-Drive Multi-Tool

(71) Applicant: Alliance Sports Group, L.P., Fort Worth, TX (US)

(72) Inventor: Gregory Lee Horne, Euless, TX (US)

(21) Appl. No.: 17/499,356

(22) Filed: Oct. 12, 2021

Related U.S. Application Data
(60) Provisional application No. 63/124,338, filed on Dec. 11, 2020.

(51) Int. Cl. B25F 1/00; B25F 1/04

(52) U.S. Cl. CPC B25F 1/003; B25F 1/04

(57) ABSTRACT

A multi-tool is disclosed having an improved armature that centers a removable tool about a vertical and horizontal axis of an end of the foldable tool when the multi-tool is in a folded position and the removable tool is extended about the end of the folded multi-tool. A locking plate mates with armature of the multi-tool to help stabilize the armature for increased torque.

### PRIORITY CLAIM

The present application claims priority to U.S. Provisional Application Ser. No. 63/124,338 filed on Dec. 11, 2020 entitled “Center-Drive Multi-Tool” which is incorporated herein by reference in its entirety.

### FIELD

The present technology relates to a multi tool with replaceable components. More specifically, a multi-tool with a center driven tool component.

### BACKGROUND

Multi-tools are a popular alternative to carrying a full tool set to solve common tool-related needs. A variety of different multi-tool arrangements are known. However, problems common to the use of these different multi-tools limit the ability for efficient operation including, but without limitation, limits of tool's structural integrity or safety as a user applies significant torque to the multi-tool. Aspects of the technology are intended to remedy that deficiency, among others.

### BRIEF DESCRIPTION OF THE DRAWINGS

Aspects of the technology will become more fully apparent from the following description, taken in conjunction with the accompanying drawings. It is to be understood that these drawings merely depict exemplary aspects and are not to be considered limiting of the disclosure's scope. It will be readily appreciated that the components of the embodiments, as generally described and illustrated in the figures herein, could be arranged and designed in a wide variety of different configurations. Nonetheless, the technology will be described and explained with additional specificity and detail through the use of the accompanying drawings in which:

FIG. 1 is a perspective side view of a multi-tool in accordance with one aspect of the technology;

FIG. 2 is a perspective side view of a multi-tool in accordance with one aspect of the technology;

FIG. 3 is a perspective view of a multi-tool in accordance with one aspect of the technology;

FIG. 4 is a perspective bottom view of a multi-tool in accordance with one aspect of the technology;

FIG. 5 is a perspective view of a back portion of a handle of a multi-tool in accordance with one aspect of the technology;

FIG. 6 is a perspective bottom view of a multi-tool in accordance with one aspect of the technology;

FIG. 7 is a perspective view of a back portion of a handle of a multi-tool in accordance with one aspect of the technology;

FIG. 8 is a perspective view of a back portion of a handle of a multi-tool in accordance with one aspect of the technology;

FIG. 9 is a perspective view of a back portion of a handle of a multi-tool in accordance with one aspect of the technology;

FIG. 10 is a perspective partially exploded view of a back portion of a handle of a multi-tool in accordance with one aspect of the technology;

FIG. 11 is a perspective view of an armature in accordance with one aspect of the technology;

FIG. 12 is a perspective view of an armature in accordance with one aspect of the technology;

FIG. 13 is a perspective view of an armature in accordance with one aspect of the technology;

FIG. 14a-14c are different views of portions of a multi tool in accordance with one aspect of the technology;

FIG. 15 is a side view of a multi tool in accordance with one aspect of the technology; and

FIG. 16 is a side view of a multi tool in accordance with one aspect of the technology.

### DESCRIPTION OF EMBODIMENTS

Although the following detailed description contains many specifics for the purpose of illustration, a person of ordinary skill in the art will appreciate that many variations and alterations to the following details can be made and are considered to be included herein. Accordingly, the following embodiments are set forth without any loss of generality to, and without imposing limitations upon, any claims set forth. It is also to be understood that the terminology used herein is for the purpose of describing particular embodiments only, and is not intended to be limiting. Unless defined otherwise, all technical and scientific terms used herein have the same meaning as commonly understood by one of ordinary skill in the art to which this disclosure belongs.

As used in this specification and the appended claims, the singular forms “a,” “an” and “the” include plural referents unless the context clearly dictates otherwise. Thus, for example, reference to “a layer” includes a plurality of such layers.

In this disclosure, “comprises,” “comprising,” “containing” and “having” and the like can have the meaning ascribed to them in U.S. Patent law and can mean “includes,” “including,” and the like, and are generally interpreted to be open ended terms. The terms “consisting of” or “consists of” are closed terms, and include only the components, structures, steps, or the like specifically listed in conjunction with such terms, as well as that which is in accordance with U.S. Patent law. “Consisting essentially of” or “consists essentially of” have the meaning generally ascribed to them by U.S. Patent law. In particular, such terms are generally closed terms, with the exception of allowing inclusion of additional items, materials, components, steps, or elements, that do not materially affect the basic and novel characteristics or function of the item(s) used in connection therewith. For example, trace elements present in a composition, but not affecting the compositions nature or characteristics would be permissible if present under the “consisting essentially of” language, even though not expressly recited in a list of items following such terminology. When using an open ended term, like “comprising” or “including,” it is understood that direct support should be afforded also to “consisting essentially of” language as well as “consisting of” language as if stated explicitly and vice versa.

The terms “first,” “second,” “third,” “fourth,” and the like in the description and in the claims, if any, are used for distinguishing between similar elements and not necessarily for describing a particular sequential or chronological order. It is to be understood that any terms so used are interchangeable under appropriate circumstances such that the embodiments described herein are, for example, capable of operation in sequences other than those illustrated or otherwise described herein. Similarly, if a method is described herein as comprising a series of steps, the order of such steps as presented herein is not necessarily the only order in which such steps may be performed, and certain of the stated steps may possibly be omitted and/or certain other steps not described herein may possibly be added to the method.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments described herein are, for example, capable of operation in other orientations than those illustrated or otherwise described herein. The term “coupled,” as used herein, is defined as directly or indirectly connected in an electrical or nonelectrical manner. Objects described herein as being “adjacent to” each other may be in physical contact with each other, in close proximity to each other, or in the same general region or area as each other, as appropriate for the context in which the phrase is used. Occurrences of the phrase “in one embodiment,” or “in one aspect,” herein do not necessarily all refer to the same embodiment or aspect.

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, generally speaking the nearness of completion will be so as to have the same overall result as if absolute and total completion were obtained. The use of “substantially” is equally applicable when used in a negative connotation to refer to the complete or near complete lack of an action, characteristic, property, state, structure, item, or result. For example, a composition that is “substantially free of” particles would either completely lack particles, or so nearly completely lack particles that the effect would be the same as if it completely lacked particles. In other words, a composition that is “substantially free of” an ingredient or element may still actually contain such item as long as there is no measurable effect thereof.

As used herein, the term “about” is used to provide flexibility to a numerical range endpoint by providing that a given value may be “a little above” or “a little below” the endpoint. Unless otherwise stated, use of the term “about” in accordance with a specific number or numerical range should also be understood to provide support for such numerical terms or range without the term “about”. For example, for the sake of convenience and brevity, a numerical range of “about 50 angstroms to about 80 angstroms” should also be understood to provide support for the range of “50 angstroms to 80 angstroms.”

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 to about 5” should be interpreted to include not only the explicitly recited values of about 1 to about 5, but also include individual values and sub-ranges within the indicated range. Thus, included in this numerical range are individual values such as 2, 3, and 4 and sub-ranges such as from 1-3, from 2-4, and from 3-5, etc., as well as 1, 2, 3, 4, and 5, individually.

This same principle applies to ranges reciting only one numerical value as a minimum or a maximum. Furthermore, such an interpretation should apply regardless of the breadth of the range or the characteristics being described.

Reference throughout this specification to “an example” means that a particular feature, structure, or characteristic described in connection with the example is included in at least one embodiment. Thus, appearances of the phrases “in an example” in various places throughout this specification are not necessarily all referring to the same embodiment.

Reference in this specification may be made to devices, structures, systems, or methods that provide “improved” performance. It is to be understood that unless otherwise stated, such “improvement” is a measure of a benefit obtained based on a comparison to devices, structures, systems or methods in the prior art. Furthermore, it is to be understood that the degree of improved performance may vary between disclosed embodiments and that no equality or consistency in the amount, degree, or realization of improved performance is to be assumed as universally applicable.

An initial overview of the technology is provided below and specific technology embodiments are then described in further detail. This initial summary is intended to aid readers in understanding the technology more quickly, but is not intended to identify key or essential features of the technology, nor is it intended to limit the scope of the claimed subject matter.

Broadly speaking, aspects of the current technology improves the ability to open and use a folding multi-tool as well as a balanced center drive component for improved functioning of the folding multi-tool. In one aspect of the technology, the multi-tool comprises channel-shaped handles having first and second ends. The generally channel-shaped handle has an open top and open bottom side. A first end of the channel-shaped handle comprises plier receiving openings. The folding multi-tool comprises pliers with first and second plier halves pivotally mounted to each other. The respective plier ends of the first and second plier halves are coupled to corresponding channel-shaped handle ends. The folding multi-tool is foldable between a first configuration for operating the pliers and a second configuration for storing the pliers within the channels of the channel-shaped handles. When the folding multi-tool is in the second or closed configuration, storing the pliers within the channel-shaped handles, a plurality of tools may be pivotally rotated out of the top of the channel-shaped handles for use, though the pivotally rotating tools may also be rotated out of the handle when in the first or open configuration.

In one aspect of the technology, one of the plurality of tools is pivotally mounted within a channel of the channel-shaped handle comprises an armature with a socket configured to receive a tool (e.g., a tool bit or other tool, etc.) therein. The armature comprises two arms that extend outward from a pin with the socket disposed between the distal end of the two arms. The armature may be locked into place in two positions; a first position wherein the armature is disposed at 90-degree angle with respect to a longitudinal axis of the channel-shaped handle, and a second position wherein the armature is configured to orient the bit such that it is located within the center of vertical and lateral axis of the channel-shaped handles when the handles are in a closed position.

In another aspect of the technology, the channel-shaped handles are defined, in part, by opposing side walls. In one aspect, the sidewall comprises a void allowing a user to access one of the tools for pivoting the tool outside of the handle. In one aspect, a stud is mounted about one of the plurality of tools which extends laterally away from the tool and through the void in the sidewall facilitating improved displacement of the tool out of the handle. In another aspect, a tab or lever is disposed about rear portion of the tool extending upward out of a top of the channel of the channel-shaped handle, also facilitating improved displacement of the tool out of the handle.

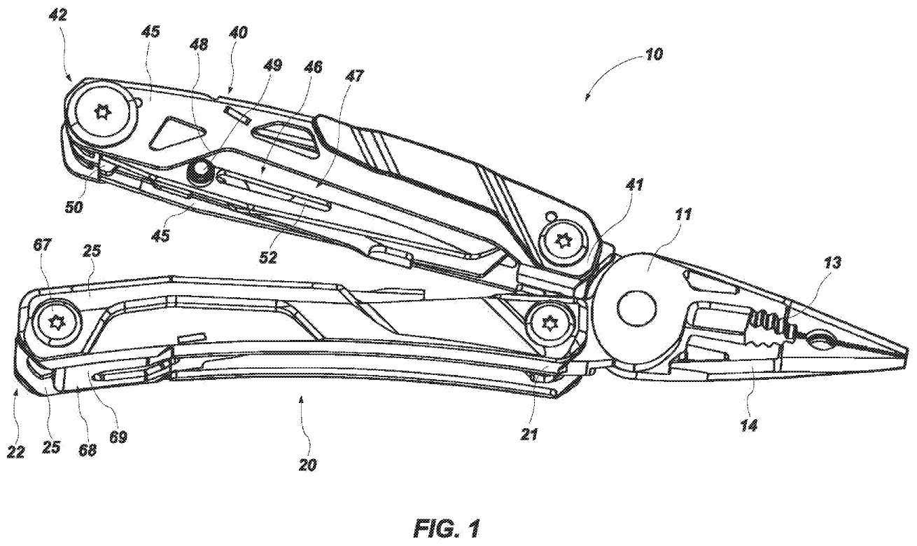

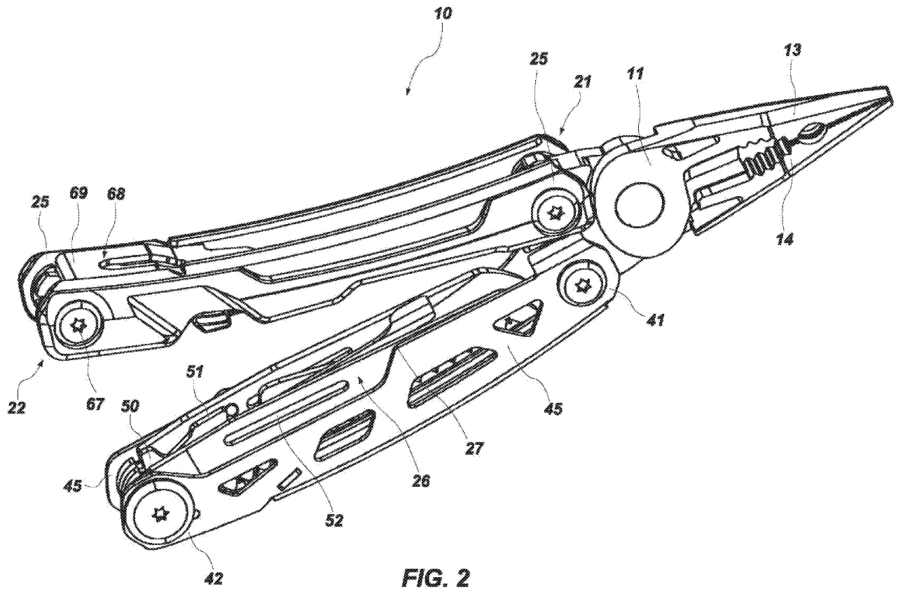

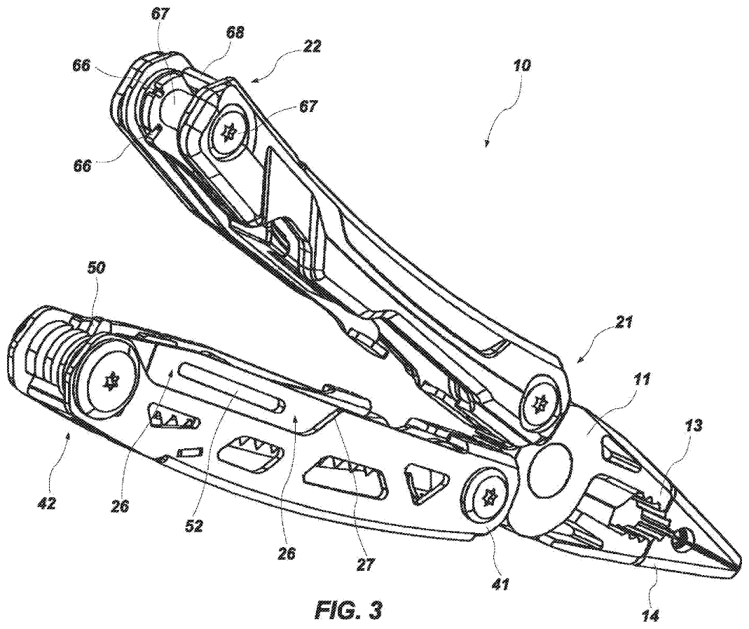

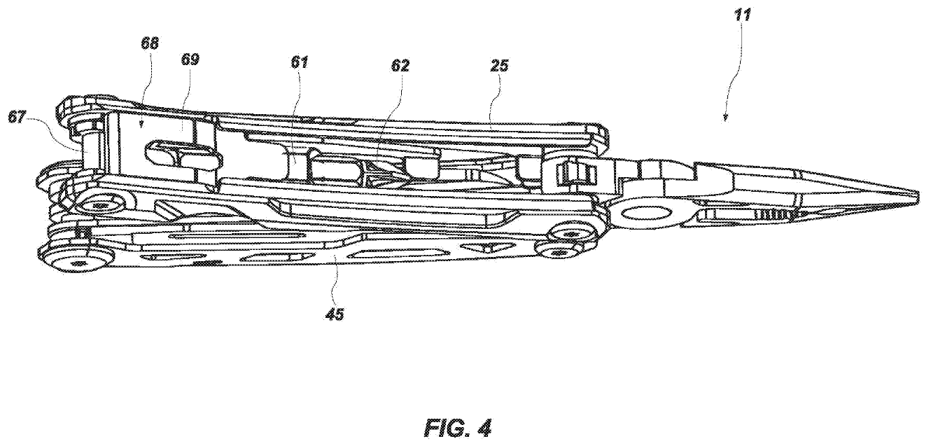

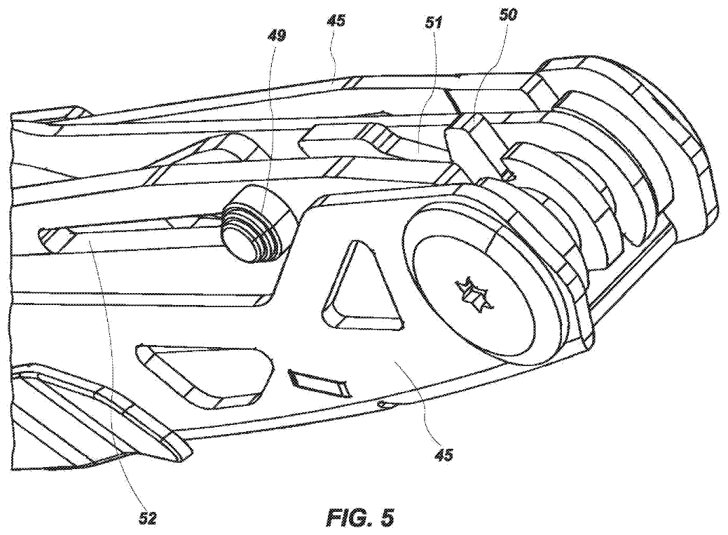

With references to FIGS. 1-5, a multi-tool 10 is disclosed in accordance with one aspect of the technology. In one aspect, the multi-tool 10 comprises first and second channel-shaped handles 20, 40, each having a first end 21, 41 and a second end 22, 42, respectively. Each generally channel-shaped handle 20, 40 has a generally open top side and open bottom side. A first end 21, 41 of the channel-shaped handles 20, 40 comprises plier receiving openings. The folding multi-tool 10 comprises pliers 11, including first and second plier halves 13, 14 pivotally mounted to each other with respective plier ends coupled to corresponding channel-shaped handles 20, 40. The folding multi-tool 10 is foldable between a first closed configuration for operating the pliers 11 and a second closed configuration for storing the pliers 11 within the channels of the channel-shaped handles 20, 40. When the folding multi-tool 10 is in the second closed configuration, storing the pliers 11 within the channel-shaped handles 20, 40, one or more of a plurality of tools may be pivotally rotated out of the top of the channel-shaped handles 20, 40 for use. In one aspect, when the folding multi-tool 10 is in the open configuration, one or more of the tools can be pivotally rotated out of the bottom of the channel-shaped handles 20, 40.

In one aspect of the technology, the channel-shaped handles 20, 40 are defined, in part, by opposing side walls 25, 45. In one aspect, the sidewalls 25, 45 comprise a void 26, 46 allowing a user to access one of the tools for pivoting the tool outside of the handle. In one aspect of the technology, the void 26 extends from a proximal portion of the handle 40 near a first end 41 to a medial portion 27 of the handle 40. In addition, the void 26 extends from a bottom edge of the side wall 25 to between ⅓ to ½ of the width of the sidewall 25. In this manner, a significant portion of one of the tools is exposed for easier access to the tool and additional safety as a user attempts to expose a tool for use. In another aspect, a void 46 extends from a distal portion of the handle near a second end 42 to a proximal portion of the handle near the first end 41. Void 46 is on a side of handle 40 that is opposite the side comprising void 26. The void 46 extends from a bottom edge of the sidewall 45 in a first sloped configuration in a first part 47 of the void and a second sloped configuration in a second part 48 of the void 46. In one aspect, a stud 49 or protrusion is disposed about a portion of the tool that is adjacent the void 46. The stud 49 extends laterally away from the side of the tool and through the void 46 to enable a user to rotate the tool out of the handle 40 more easily. In another aspect, one or more of the plurality of tools that are pivotally mounted in the handles 20, 40 comprise a tab or lever 50 is disposed about rear portion about a back side 51 of the tool extending upward out of a top of the channel of the channel-shaped handle 40, also facilitating improved pivoting of the tool. In an additional aspect, one or more of the plurality of tools comprises a groove 52 or aperture within the tool to further facilitate rotation of the tool out of the handle 40.

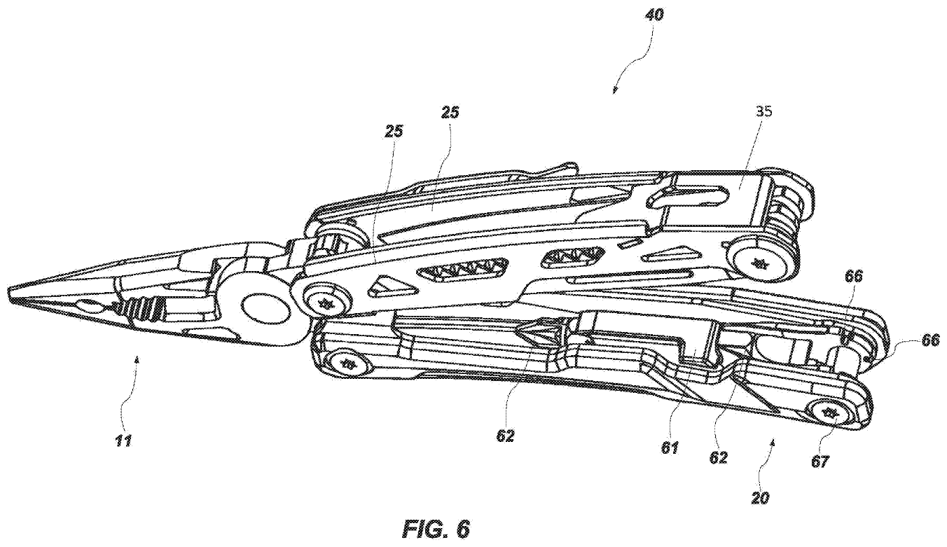

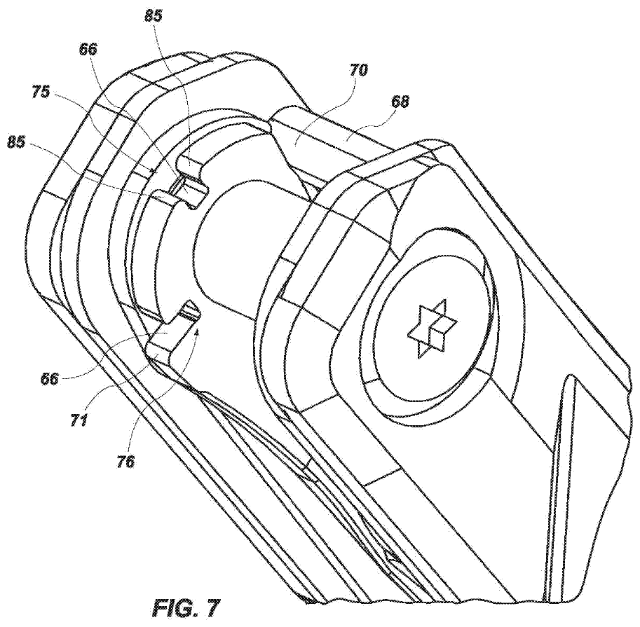

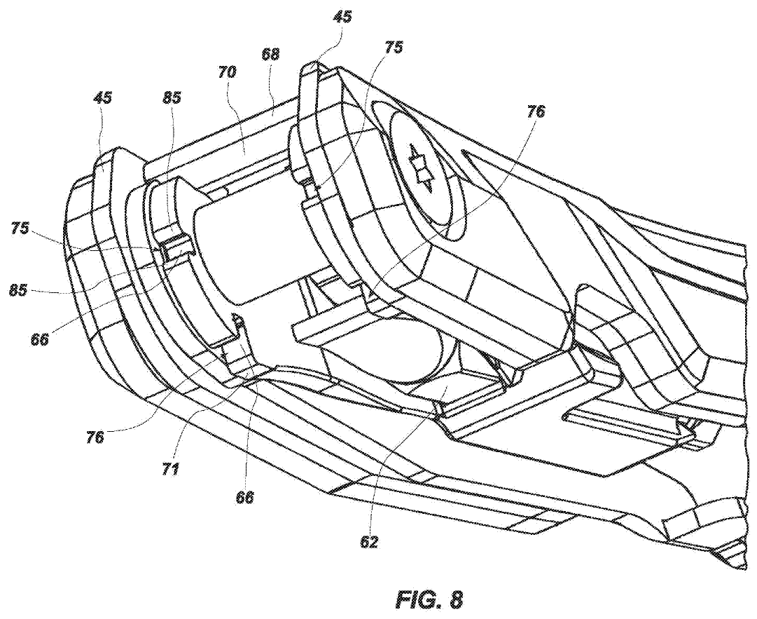

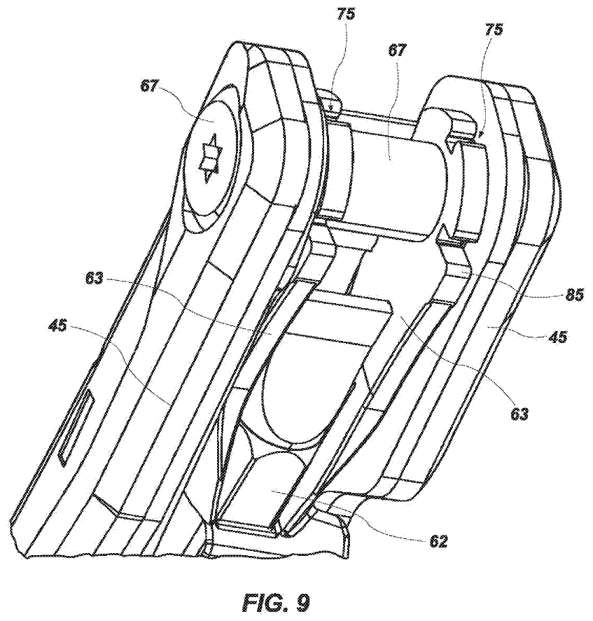

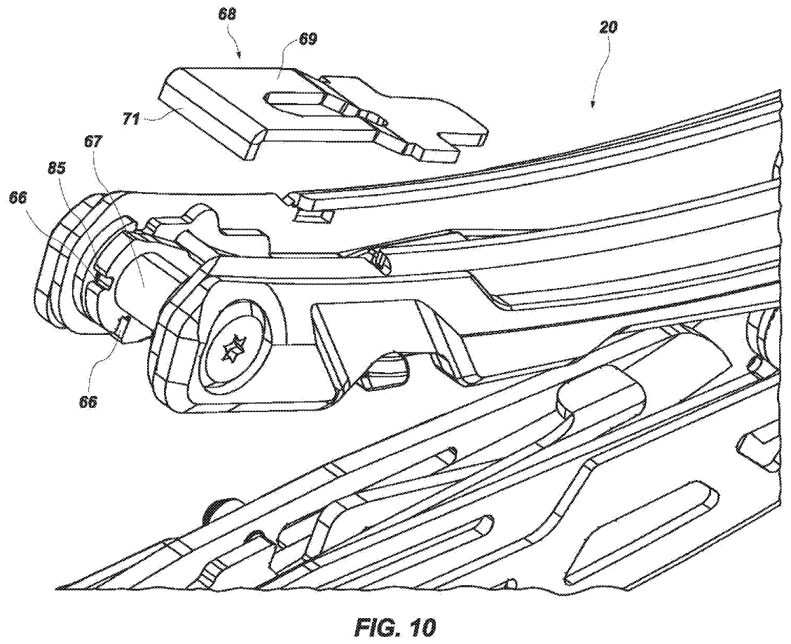

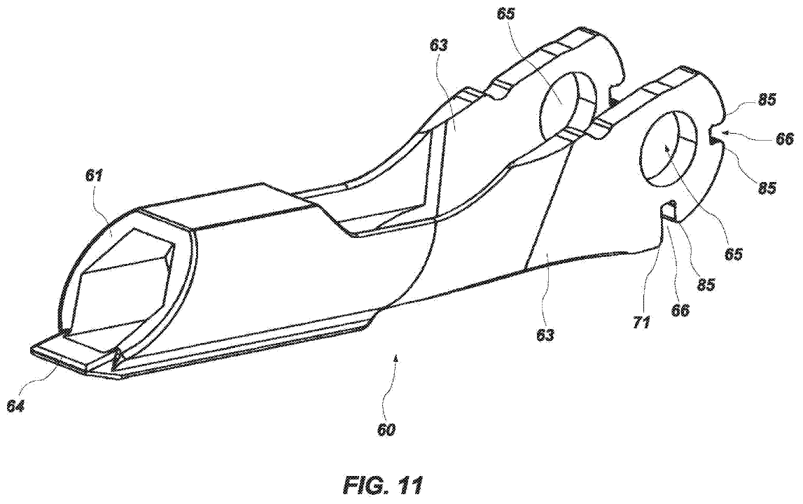

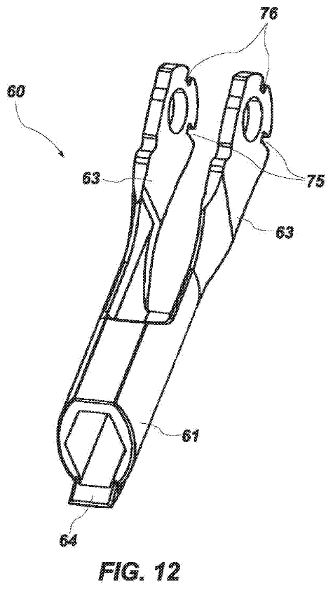

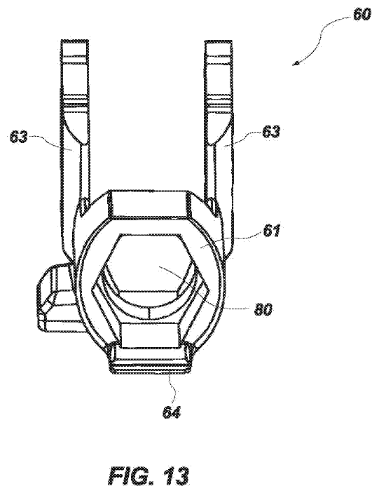

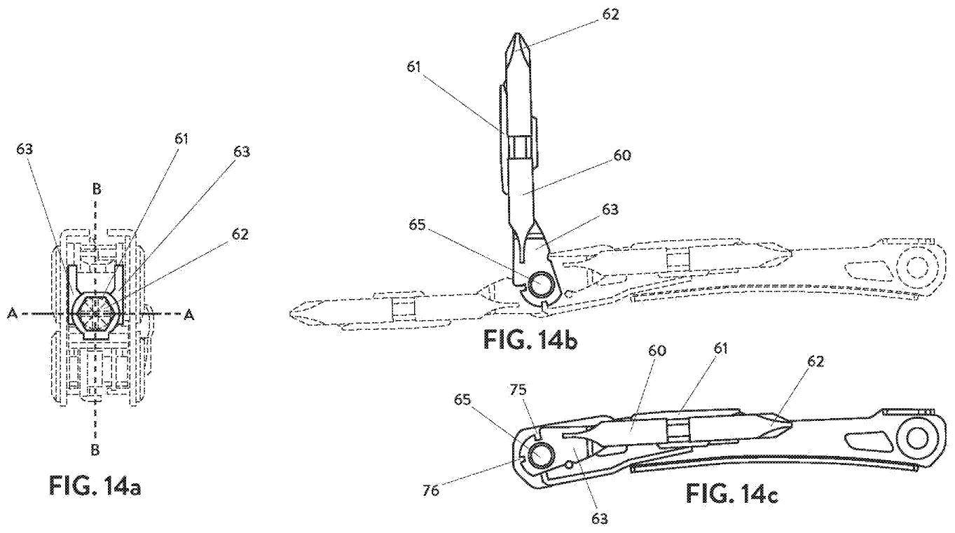

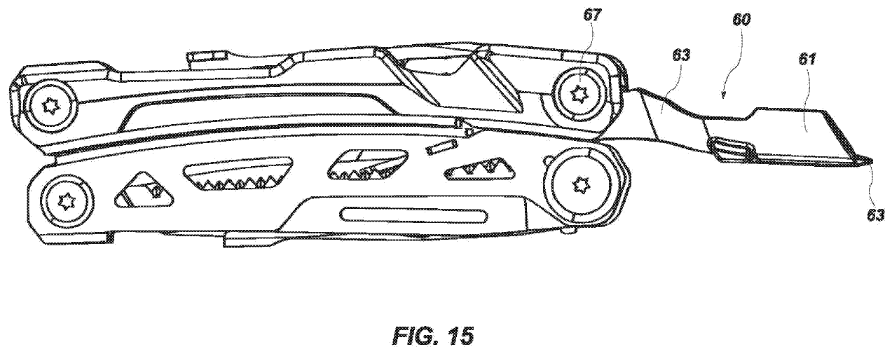

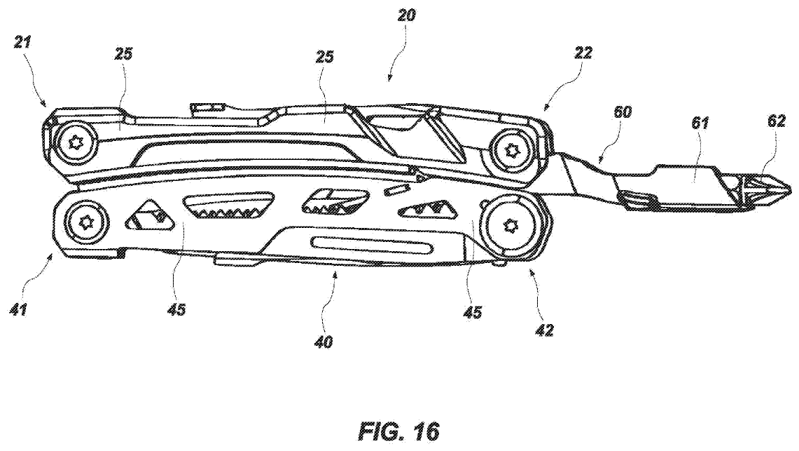

With reference to FIGS. 6-16, in one aspect of the technology, one of the plurality of tools pivotally mounted within a channel of the channel-shaped handles 20, 40 comprises an armature 60 with a socket 61 configured to receive a bit 62 (e.g., a screwdriver bit, knife bit, etc.) in the socket 61. In one aspect of the technology, the socket 61 comprises a magnet configured to couple with a magnet disposed on an end of the bit 62. In one aspect, the armature 60 comprises two arms 63 that extend outward from a pin 65 with the socket 61 disposed between the distal end of the two arms 63. The armature 60 may be locked or secured into place in two positions; a first position wherein the armature 60 is disposed at 90 degree angle with respect to a longitudinal axis of the channel-shaped handles 20, 40, (as shown in FIG. 14b) and a second position wherein the armature 60 is disposed substantially parallel with a longitudinal axis of the channel-shaped handles 20, 40 (as shown in FIG. 14a). When the armature 60 is in the second position, the center of the socket 61 is disposed within the center of vertical axis B-B and lateral axis A-A of the channel-shaped handles when they are in a closed position as illustrated in FIG. 14a. The dual arm armature 60 and centered orientation of the armature with respect to the channel-shaped handles improves the ability of the user to apply more torque to the tool without bending the armature 60 or other components of the multi-tool.

In one aspect of the technology, the socket further comprises a lip 64 that facilitates placement of the bit 62 within the socket 61. In another aspect, the socket 61 comprises a through-hole 80 where a reversible tool bit may be disposed. The reversible bit may comprise a screwdriver head on one end and a knife bit on an opposite end, a flat head bit one end and a Phillips bit on an opposite end, or any number of different arrangements.

In one aspect of the technology, the arms 63 of the armature 60 comprise a curvilinear top and bottom wall to facilitate placement of the armature 60 within the curvilinear sidewalls of the channels and permit placement of the bit within the armature 60 and the channels when the tool is rotated into a storage or closed position. The arms 63 terminate at a proximal end having a through hole 65 that is configured to couple with a pin 67 for rotating the armature 60. The rear or terminating portion of the arms 63 comprise a plurality of locking grooves 66 or indentations disposed about a perimeter of the rear portion of the arms. The indentations 66 are placed about the exterior of the arms 63 and spaced such that as the armature 60 is rotated about the pin 67 out of the channel of handle 20, the indentations 66 are engaged by the locking plate 68.

Locking plate 68 comprises a substantially flat back end 69 disposed about a second end 22 of handle 20 terminating in a lip 70 that is biased against the top of the arms 63 of the armature 60. When the armature 60 is rotated out of a closed position, the lip 70 will engage or be pushed into the second set of indentations 76 on the arms 63 securing the armature in a 90 degree position with respect to a longitudinal axis of the handles. This position provides the user with the ability to more easily apply additional torque to the armature 60. When an amount of pressure is placed on the armature 60 to further rotate the armature about the pin 65, the lip 70 is disengaged from the second set of indentations 76 allowing additional rotation of the armature 60. As the armature 60 is rotated into a fully extended position, the lip 70 of locking plate 68 engages with the first set of indentations 75. While first and second indentations are referred to herein, it is understood that the tool may comprise a single indentation or three or more indentations to allow the armature to be “locked” temporarily into a plurality of different positions.

In one aspect of the technology, a locking plate 35 is disposed about handle 40 to facilitate locking of the tools disposed in handle 40 as a lip of locking plate 35 engages with grooves or indentations of a rear portion of a particular tool.

In one aspect, a shoulder 85 of the indentations 66 is rounded to facilitated movement of the lip 70 into and out of the indentations 66. A tab 71 is disposed about one side of the second set of indentations to prevent the armature 60 from being over-rotated beyond the fully extended position. The back side 69 of the locking plate 68 prevents the armature 60 from rotating out of the closed position through a back side of the channel-shaped handle 20. In one aspect, the second set of indentations 76 are deeper than the first set of indentations 75, though the reverse may also be true, that that first set of indentations is deeper than the second. In another aspect, the depth of the first and second indentations are the same. In another aspect, the shape of the lip 70 is shaped to approximate the shape of the indentations 66. For example, the lip 70 and indentations 66 may be rectangular, triangular, curvilinear, etc.

In one aspect of the technology, the armature 60 comprises an inner socket and an outer socket. In one aspect, the inner socket is oppose the outer socket on the armature. When the armature 60 is in a first position, pivotally extended outside of the channel, the bit 62 is placed in the outer socket so that the bit may be used as a tool. For purposes of explanation, in this aspect, the first position could be the 90 degree position or fully extended position. When the armature 60 is in a second position, pivotally rotated into the channel of the handle for storage, the bit 62 may be placed in the inner socket. In one aspect of the technology, the tool comprises two bits; one placed in the inner socket and one placed in the outer socket. In yet another example, the armature comprises a single socket configured to receive a two-sided tool bit that extends though the socket. In this manner, the single tool bit may be removed from the socket and its orientation reversed in order to facilitate different needs of the user.

The above description provides numerous specific details for a thorough understanding of the embodiments described herein. However, those of skill in the art will recognize that one or more of the specific details may be omitted, or other methods, components, or materials may be used. In some cases, operations are not shown or described in detail. Furthermore, the described features, operations, or characteristics may be combined in any suitable manner in one or more aspects. It will also be readily understood that the order of the steps or actions described in connection with the aspects disclosed may be changed as would be apparent to those skilled in the art.

The foregoing detailed description describes the technology with reference to specific exemplary embodiments. However, it will be appreciated that various modifications and changes can be made without departing from the scope of the present disclosure. The detailed description and accompanying drawings are to be regarded as merely illustrative, rather than as restrictive, and all such modifications or changes, if any, are intended to fall within the scope of the present disclosure as described and set forth herein.

1. A foldable tool having a replaceable component, comprising:
a plurality of channel-shaped handles coupled together by a first tool;
an armature rotatably coupled to a first end of a first one of the plurality of channel-shaped handles and configured to be disposed within a cavity of the first one of the plurality of channel-shaped handle in a first position and extended outside of the first one of the plurality of channel-shaped handle in a second position; and
a second tool removably disposed within the armature, the second tool being centered about a vertical and horizontal axis of an end of the foldable tool when the armature is extended out of the first one of the plurality of channel-shaped handles in the second position and disposed substantially parallel with a longitudinal axis of the plurality of channel-shaped handles.

2. The foldable tool of claim 1, wherein the armature comprises a first arm mounted to a socket and a second arm mounted to the socket.

3. The foldable tool of claim 2, wherein the first arm and the second arm are substantially parallel.

4. The foldable tool of claim 3, wherein the socket is centered between the first arm and the second arm and is disposed about distal ends of the first arm and the second arm.

5. The foldable tool of claim 4, wherein when the armature is in the first position the first and second arms are substantially parallel with the first one of the plurality of channel-shaped handles.

6. The foldable tool of claim 4, wherein the socket comprises a first side and a second side opposite the first side, the first side and the second side each comprising an opening configured to removable receive the second tool therein.

7. The foldable tool of claim 6, wherein the opening of the first side of the socket and the opening of the second side of the socket have a similar height and similar width.

8. The foldable tool of claim 6, wherein when the second tool is disposed within the second side of the socket, the second tool is located between the first and second arms of the armature.

9. The foldable tool of claim 2, further comprising a locking plate disposed about the first one of the plurality of channel-shaped handles, the locking plate comprising a lip configured to engage with indentations disposed about the first arm and the second arm of the armature.

10. A foldable tool having a replaceable component, comprising:
a plurality of channel-shaped handles coupled together;
an armature rotatably coupled to a first end of a first one of the plurality of channel-shaped handles and configured to be disposed within a cavity of the first one of the plurality of channel-shaped handle in a first position and extended outside of the first one of the plurality of channel-shaped handle in a second position;
a tool removably disposed within the armature, the second tool being centered about a vertical and horizontal axis of an end of the foldable tool when the armature is extended out of the first one of the plurality of channel-shaped handles in the second position; and
a locking plate disposed about the first one of the plurality of channel-shaped handles, the locking plate comprising a lip.

11. The foldable tool of claim 10, wherein the lip is disposed at a non-parallel angle relative to a longitudinal axis of the locking plate.

12. The foldable tool of claim 11, wherein the armature comprises first and second arms rotatably mounted about an end portion of the first one of the plurality of channel-shaped handles, the first and second arms each comprising a first indentation and a second indentation.

13. The foldable tool of claim 12, wherein the first indentation on the first arm is disposed opposite the first indentation of the second arm and is configured to mate with the lip of the locking plate, the first indentation on the first and second arms having a rounded shoulder.

14. The foldable tool of claim 12, wherein the second indentation on the first arm is disposed opposite the second indentation of the second arm, the second indentation on the first and second arms configured to mate with the lip of the locking plate.

15. The foldable tool of claim 12, wherein the first indentation on the first and second arms comprises a first depth and the second indentation on the first and second arms comprises a second depth, the first depth being less than the second depth.

16. The foldable tool of claim 12, wherein the first indentation on the first and second arms is disposed a first distance from a distal end of the armature and the second indentation on the first and second arms is disposed a second distance from the distal end of the armature, the first distance is greater than the second distance.

17. A foldable tool having a replaceable component, comprising:
a plurality of channel-shaped handles coupled together by a first tool;
an armature having first and second arms, the armature rotatably coupled to a first end of a first one of the plurality of channel-shaped handles and configured to be disposed within a cavity of the first one of the plurality of channel-shaped handle in a first position and extended outside of the first one of the plurality of channel-shaped handle in a second position;
a second tool removably disposed within a socket of the armature, the second tool being centered about a vertical and horizontal axis of an end of the foldable tool; and
a locking plate disposed about the first one of the plurality of channel-shaped handles, the locking plate comprising a lip configured to mate with first and second indentations disposed about the first and second arms of the armature as the armature is rotated from the first position and extended outside of the first one of the plurality of channel-shaped handles.

18. The foldable tool of claim 17, further comprising third and fourth tools rotatably mounted in a second one of the plurality of channel-shaped handles.

19. The foldable tool of claim 18, wherein the second one of the plurality of channel-shaped handles comprises first and second side walls defining an opening that houses the third and fourth tools.

20. The foldable tool of claim 19, the first sidewall comprises a void extending from a proximal portion of the handle near a first end to a medial portion of the handle, the void extends from a bottom edge of the side wall to between ⅓ and ½ of the width of the sidewall.
